(19) United States
(12) Patent Application Publication
(10) Pub. No.: US 2019/0228493 A1
(43) Pub. Date: Jul. 25, 2019

(54) INFORMATION PROCESSING APPARATUS, INFORMATION PROCESSING METHOD, AND NON-TRANSITORY COMPUTER-READABLE STORAGE MEDIUM

(71) Applicants: Toyota Jidosha Kabushiki Kaisha, Toyota-shi Aichi-ken (JP); DENSO TEN Limited, Kobe-shi Hyogo (JP)

(72) Inventors: Takashige Hori, Aisai-shi Aichi-ken (JP); Masanobu Washio, Kobe-shi Hyogo (JP)

(73) Assignees: Toyota Jidosha Kabushiki Kaisha, Toyota-shi Aichi-ken (JP); DENSO TEN Limited, Kobe-shi Hyogo (JP)

(21) Appl. No.: 16/249,670

(22) Filed: Jan. 16, 2019

(30) Foreign Application Priority Data
Jan. 22, 2018 (JP) 2018-007933

(51) Int. Cl. G06Q 50/30; G06Q 10/10; G06F 3/0481

(52) U.S. Cl. CPC G06Q 50/30; G06F 3/04817; G06Q 10/1093

(57) ABSTRACT

An information processing apparatus includes a reading unit configured to read first schedule information including, a start time and an end time of a schedule for a user and positional information for the user, from a schedule management database in which user's schedules are managed, a search unit configured to perform a search based on a search condition according to the start time or the end time and the positional information included in the first schedule information to generate a plurality of pieces of transportation candidate information each including a transportation start time and a transportation end time, a display unit configured to display a plurality of icons corresponding to the pieces of transportation candidate information on a display screen, and a registration unit configured to register the transportation candidate information selected from among the pieces of transportation candidate information as transportation schedule information in the schedule management database.

### CROSS-REFERENCE TO RELATED APPLICATIONS

This application claims priority to Japanese Patent Application No. 2018-007933 filed on Jan. 22, 2018, which is incorporated herein by reference in its entirety including the specification, drawings and abstract.

### BACKGROUND

### 1. Technical Field

The present disclosure relates to an information processing apparatus, an information processing method, and a non-transitory computer-readable storage medium storing an information processing program.

### 2. Description of Related Art

Japanese Unexamined Patent Application Publication No. 2014-215142 (JP 2014-215162 A) describes a technique that searches for a recommended transportation route by extracting a departure place and a destination related to a schedule accompanied with transportation by an automobile from schedule data and automatically registers a transportation schedule including a departure time at the departure place as schedule data in a database.

### SUMMARY

Here, in the method of JP 2014-215162 A, the one searched recommended transportation route is registered as schedule data. However, in regard to a transportation method from a point (departure place) of a certain schedule to a point (destination) of a next schedule, a plurality of transportation methods including a transportation method of departing soon after the schedule ends, a transportation method of arriving at the destination immediately before the schedule starts, and the like is usually considered.

The disclosure provides an information processing apparatus, an information processing method, and a non-transitory computer-readable storage medium storing an information processing program capable of suitably registering a schedule related to transportation.

A first aspect of the disclosure relates to an information processing apparatus. The information processing apparatus includes a reading unit, a search unit, a display unit, and a registration unit. The reading unit is configured to read first schedule information including a start time and an end time of a schedule for a user and positional information for the user from a schedule management database in which user's schedules are managed. The search unit is configured to perform a search based on a search condition according to the start time or the end time and the positional information included in the first schedule information to generate a plurality of pieces of transportation candidate information each including a transportation start time and a transportation end time. The display unit is configured to display a plurality of icons corresponding to the plurality of pieces of transportation candidate information on a display screen. The registration unit is configured to register the transportation candidate information selected from among the plurality of pieces of transportation candidate information as transportation schedule information in the schedule management database.

In the information processing apparatus according to the first aspect of the disclosure, the transportation candidate information may include transportation route information. When one of the plurality of icons displayed on the display screen is selected, the display unit may display the transportation route information related to the transportation candidate information corresponding to the selected icon.

In the information processing apparatus according to the first aspect of the disclosure, when one of the plurality of icons displayed on the display screen is selected, the display unit may register the transportation candidate information corresponding to the selected icon as the transportation schedule information in the schedule management database.

In the information processing apparatus according to the first aspect of the disclosure, the reading unit may read the first schedule information and second schedule information including a start time later than the end time of the first schedule information. The search unit may perform a search based on the search condition that the positional information included in the first schedule information is set as a departure place and the positional information included in the second schedule information is set as a destination.

In the information processing apparatus according to the aspect of the disclosure, the search unit may perform a search based on the search condition that the same time as or a time later than the end time included in the first schedule information is set as a departure time and the same time as or a time earlier than the start time included in the second schedule information is set as an arrival time.

In the information processing apparatus according to the first aspect of the disclosure, the search unit may perform a search based on the search condition that the positional information included in the first schedule information is set as one of a departure place or a destination and the positional information related to a point registered in advance is set as the other of the departure place or the destination.

A second aspect of the disclosure relates to an information processing method. The information processing method includes reading first schedule information including a start time and an end time of a schedule for a user and positional information for the user, from a schedule management database in which user's schedules are managed, performing a search based on a search condition according to the start time or the end time and the positional information included in the first schedule information to generate a plurality of pieces of transportation candidate information each including a transportation start time and a transportation end time, displaying a plurality of icons corresponding to the plurality of pieces of transportation candidate information on a display screen, and registering the transportation candidate information selected from among the plurality of pieces of transportation candidate information as transportation schedule formation in the schedule management database.

A third aspect the disclosure relates to a non-transitory computer-readable storage medium storing an information processing program. The information processing program causes a computer to execute processing for reading first schedule information including a start time and an end time of a schedule for a user and positional information for the user, from a schedule management database in which user's schedules are managed, processing for performing a search based on a search condition according to the start time or the end time and the positional information included in the first schedule information to generate a plurality of pieces of transportation candidate information each including a transportation start time and a transportation end time, processing for displaying a plurality of icons corresponding to the plurality of pieces of transportation candidate information on a display screen, and processing for registering the transportation candidate information selected from among the plurality of pieces of transportation candidate information as transportation schedule information in the schedule management database.

Note that, in the aspects of the disclosure, the “unit”, “device”, or “system” does not merely mean physical means and also includes a case where a function of the “unit”, “device”, or “system” is realized by software. Moreover, a function of one “unit”, “device”, or “system” may be realized by two or more physical means or devices, or functions of two or more “units”, “devices”, and “systems” may be realized by one physical means or device.

### BRIEF DESCRIPTION OF THE DRAWINGS

Features, advantages, and technical and industrial significance of exemplary embodiments will be described below with reference to the accompanying drawings, in which like numerals denote like elements, and wherein:

FIG. 1A is a diagram illustrating a specific example of display screen transition that an information processing apparatus according to an embodiment displays;

FIG. 1B is a diagram illustrating a specific example of display screen transition that an information processing apparatus according to an embodiment displays;

FIG. 2 is a diagram illustrating a specific example of display screen transition that the information processing apparatus according to the embodiment displays;

FIG. 3 is a block diagram showing the functional configuration of the information processing apparatus according to the embodiment;

FIG. 4 is a flowchart showing a flow of processing of the information processing apparatus shown in FIG. 3; and

FIG. 5 is a diagram showing a specific example of the hardware configuration of the information processing apparatus shown in FIG. 3.

### DETAILED DESCRIPTION OF EMBODIMENTS

Hereinafter, an embodiment will be described referring to the drawings. However, the embodiment that will be described below is merely illustrative and there is no intention of excluding application of various modifications or techniques that are not clearly described below. That is, the disclosure may be modified in various ways without departing from the spirit and scope of the disclosure. Furthermore, in the following description of the drawings, the same or similar portions are represented by the same or similar reference numerals. The drawings are not schematic ones and are not always consistent with actual dimensions, ratios, and the like. There are cases where mutual dimensional relationships and ratios are different from one another also among the drawings are included.

### Embodiment

### 1 Outline

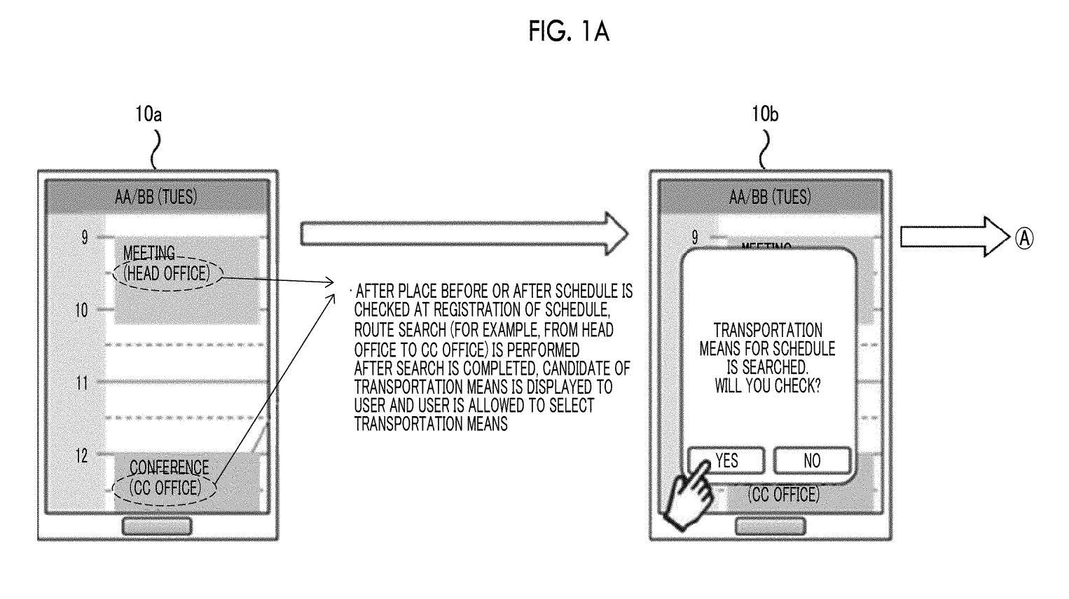

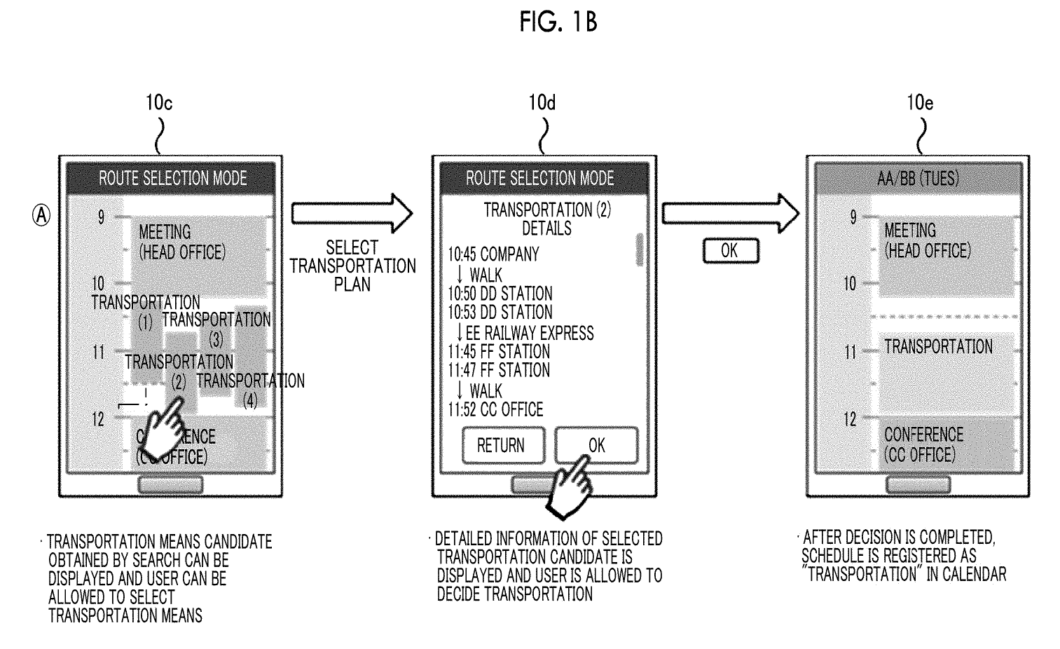

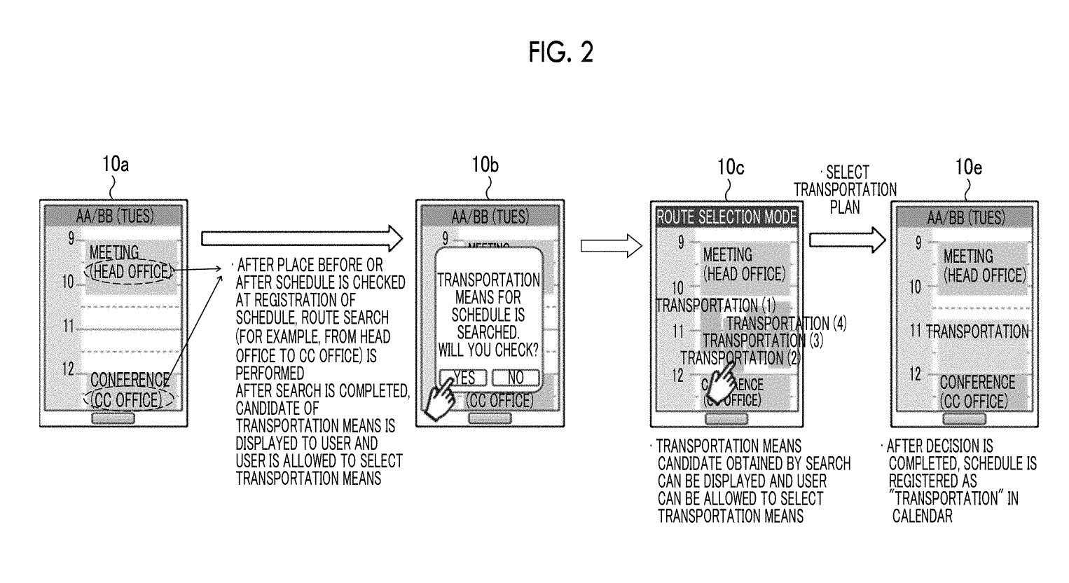

Hereinafter, an example of a display screen that an information processing apparatus according to the embodiment displays will be described referring to FIGS. 1A to 2. FIGS. 1A to 2 are diagrams showing transition of the display screen that the information processing apparatus according to the embodiment displays.

### 1.1 First Example

First, a first example of display screen transition that the information processing apparatus displays will be described referring to FIGS. 1A and 1B. The information processing apparatus can display a schedule screen 10a showing user's schedules. In the example of the schedule screen 10a, two schedules are registered, a first schedule relates to “MEETING” where a start time is 09:00, an end time is 10:15, and a place is a “HEAD OFFICE”. A second schedule relates to a “CONFERENCE” where a start time is 12:00, an end time is after 13:00, and a place is a “CC OFFICE”.

In a display state of the schedule screen 10a, when the user performs an operation to start registration processing of a schedule related to transportation between the schedules “MEETING” and “CONFERENCE”, the information processing apparatus executes route search processing for transportation between the schedules, and then, as shown on a screen 10b, and displays selectable button icons “YES”, “NO” along with a message “TRANSPORTATION MEANS FOR SCHEDULE IS SEARCHED. WILL YOU CHECK?”.

At this time, the information processing apparatus executes route search processing based on a search condition that the same time as the end time of the schedule “MEETING” or a time later than the end time of the schedule “MEETING” is a departure time, “HEAD OFFICE” is a departure place, the same time as the start time of the schedule “CONFERENCE” or a time earlier than the start time of the schedule “CONFERENCE” is an arrival time, and “CC OFFICE” is a destination, and obtains a plurality of search results of the route search processing. At this time, in order to obtain a plurality of search results, a plurality of search conditions can be used. For example, it is considered that the route search processing is executed based on a plurality of search conditions, such as a search condition that the end time of the schedule “MEETING” is a departure time, a search condition that the start time of the schedule “CONFERENCE” is an arrival time, a search condition that a transportation time becomes shortest, and a search condition that the transportation time becomes longest.

When the user selects the button icon “YES” on the screen of the screen 10b, a schedule screen 10c is displayed. In the example of the schedule screen 10c, four icons (“TRANSPORTATION (1)” to “TRANSPORTATION (4)”) indicating transportation schedule candidates of the user are displayed between the schedules “MEETING” and “CONFERENCE”.

When the user selects an icon corresponding to one transportation schedule candidate on the schedule screen 10c (in the example of FIG. 1B, “TRANSPORTATION (2)”), a screen 10d on which details of a transportation route corresponding to the transportation schedule candidate are shown is displayed. In the example shown on the screen 10d, information of a departure time and an arrival time at a departure place, a destination, and each via-point, and transportation means (in the example of the screen 10d, “WALK”, “EE RAILWAY EXPRESS”, or the like) is shown. A button icon “RETURN” and a button icon “OK” are displayed on the screen 10d. When the user selects the button icon “RETURN”, the display screen is returned to the schedule screen 10c. When the user selects the button icon “OK”, the display screen is transited to a schedule screen 10e. On the schedule screen 10e, a transportation schedule candidate (in the example of FIG. 1B, “TRANSPORTATION (2)”) selected by the user is registered in a schedule as a transportation schedule where a start time is 10:45 and an end time is 12:00. The registered transportation schedule is also registered in a schedule management database in which user's schedules are managed.

### 1.2 Second Example

Next, a second example of display screen transition that the information processing apparatus displays will be described referring to FIG. 2. Note that the screens having the same functions as in the first example described referring to FIGS. 1A and 1B are represented by the same reference numerals. Hereinafter, description will be provided focusing on a difference between the second example and the first example.

A flow of transition of displaying the schedule screen 10c from the schedule screen 10a by way of the screen 10bin the second example is the same as in the first example. However, in the second example, when the user selects one transportation schedule candidate on the schedule screen 10c, the display screen is transited to the schedule screen 10e. That is, the screen 10d of FIG. 1B on which the details of the transportation route are shown is not displayed in the second example. With this, since it is possible to reduce user's screen operations in the second example to be smaller than in the first example, it is possible to suppress complicatedness of a user's operation.

### 2 Functional Configuration

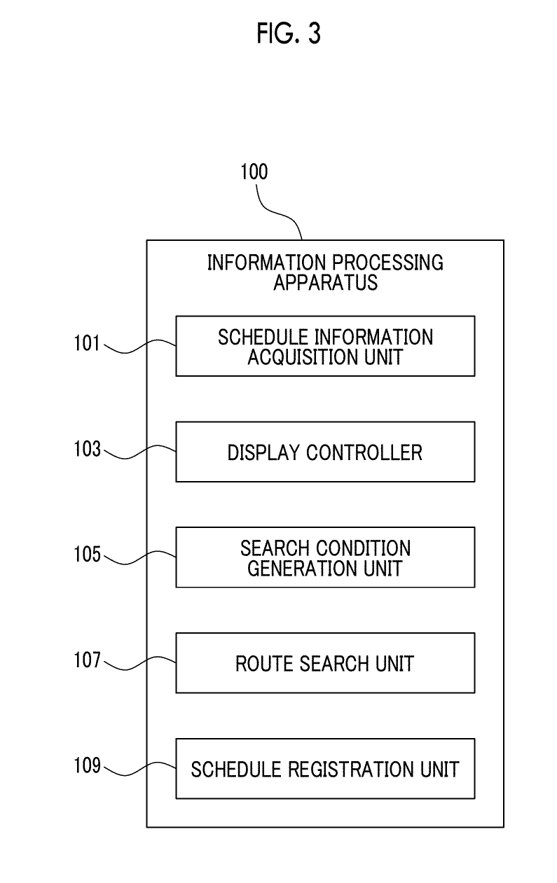

Next, the functional configuration of an information processing apparatus 100 according to the embodiment will be described referring to FIG. 3. The information processing apparatus 100 can be realized as, for example, a mobile phone (regardless of a so-called feature phone or a smartphone), a personal computer (PC), a television, or the like. The information processing apparatus 100 includes a schedule information acquisition unit 101, a display controller 103, a search condition generation unit 105, a route search unit 107, and a schedule registration unit 109.

The schedule information acquisition unit 101 reads one piece or a plurality of pieces of schedule information from the schedule management database where the user's schedules are managed. Information of a start time and an end time of a schedule, place information (positional information), a schedule name, and the like are included in the schedule information. Here, the schedule management database may be incorporated in the information processing apparatus 100 or may be managed by an external server or the like. When the external server manages the schedule management database, the schedule information acquisition unit 101 requests the external server to transmit the schedule information of the user that is managed in the schedule management database.

The display controller 103 makes a display device display the display screen and the like described referring to FIGS. 1A to 2. Specifically, for example, the display controller 103 generates the schedule screens 10a and 10e using the schedule information acquired by the schedule information acquisition unit 101 and makes the display device display the schedule screens 10a and 10e. Furthermore, the display controller 103 also makes the display device display the schedule screen 10c on which each of transportation schedule candidates to be obtained as a result of a search in the route search unit 107 described below is disposed as an icon or the screen 10d on which the details of the transportation route of the selected transportation schedule candidate are shown.

The search condition generation unit 105 generates a plurality of search conditions for a search in the route search unit 107 using the schedule information acquired by the schedule information acquisition unit 101. The search condition can include information of at least one of a departure place, a destination, a departure time, and an arrival time. Specifically, for example, using schedule information (hereinafter, simply referred to as “first schedule information”) relating to a schedule immediately before a period during which transportation schedule information is about to be registered and schedule information (hereinafter, simply referred to as “second schedule information”) relating to a schedule immediately after the period, the search condition generation unit 105 may generate a search condition that the place of the first schedule information is a departure place and the place of the second schedule information is a destination. At this time, an end time of the first schedule information or a time later than the end time of the first schedule information may be set as the departure time of the search condition. Alternatively, a start time of the second schedule information or a time earlier than the start time of the second schedule information may be set as the arrival time of the search conditions. Furthermore, various conditions of a route having a transportation time as short or long as possible, a route with a small number of transfers, or the like may be included in the search conditions. For example, when the search condition generation unit 105 generates four search conditions, it is considered that a first search condition that the end time of the first schedule information is a departure time, a second search condition that the start time of the second schedule information is an arrival time, a third search condition for searching for a route having the shortest transportation time among routes having a time later than the end time of the first schedule information as a departure time and a time earlier than the start time of the second schedule information as an arrival time, and a fourth search condition for searching for a route having the longest transportation time among the routes are generated.

It is also considered that the search condition generation unit 105 sets a preset point as a departure place or a destination or sets use of a first train or a last train as a search condition. Specifically, for example, when schedule information of a conference where an end time is 18:00 and a place is “CC OFFICE” is registered in the schedule management database, it is considered that the search condition generation unit 105 generates a search condition that “CC OFFICE” is a departure place, home is a destination, a departure time is 18:00, and a last train is used.

The route search unit 107 executes the route search processing using the search conditions generated by the search condition generation unit 105. An actual route search may be performed by the external server. In this case, the route search unit 107 may transmit the search conditions to the external server and receive search results as transportation schedule candidates.

The schedule registration unit 109 registers a transportation schedule candidate selected by the user from among the transportation schedule candidates obtained as a result of the search in the route search unit 107 as a transportation schedule in the schedule management database. As described above, the schedule management database may be managed by the information processing apparatus 100 or may be managed by the external server.

### 3 Flow of Processing

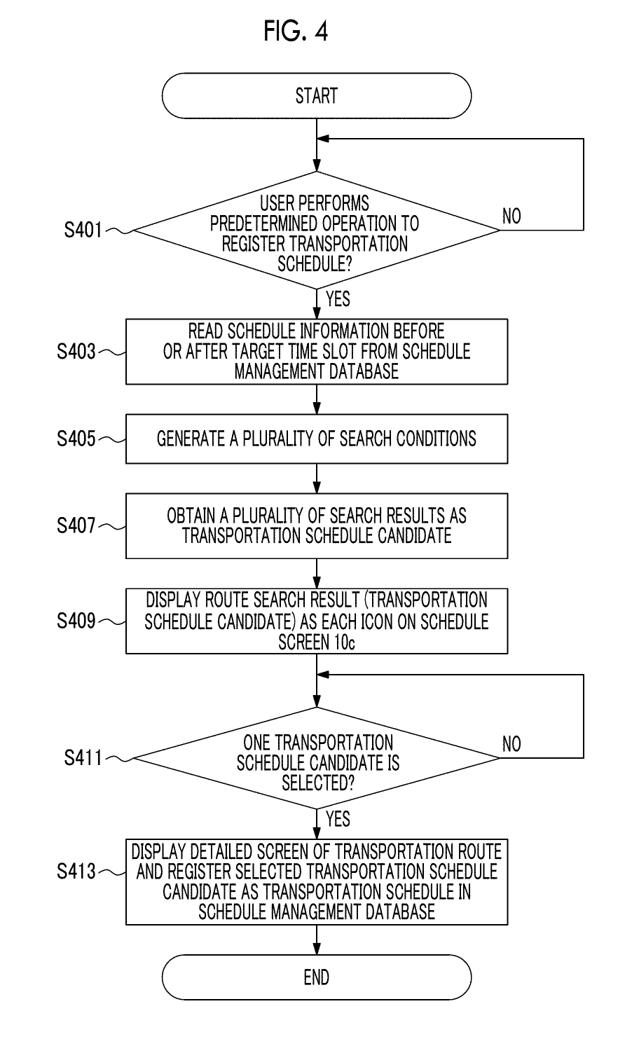

Hereinafter, a flow of processing of the information processing apparatus 100 will be described referring to FIG. 4. FIG. 4 is a flowchart showing a flow of processing of the information processing apparatus 100.

Steps of processing described below can be executed in a different order or in parallel as appropriate, or another step may be added between the steps unless inconsistency occurs in the processing details. Furthermore, a step that is described as a single step for convenience may be executed dividing the step into multiple steps, or steps that are described as separate steps for convenience may be executed as a single step.

For example, when the user performs a predetermined operation to register a transportation schedule on the schedule screen 10a shown in the specific examples in FIGS. 1A to 2 (in S401, Yes), the schedule information acquisition unit 101 reads the schedule information before and after a target period from the schedule management database (S403). When a homecoming route or a departure route from home is searched, it is considered that the number of pieces of schedule information read by the schedule information acquisition unit 101 is set to one.

The search condition generation unit 105 generates a plurality of search conditions using the schedule information acquired by the schedule information acquisition unit 101 (S405). Since the generation method of the search conditions in the search condition generation unit 105 is described above, the description will not be repeated here.

The route search unit 107 executes the route search processing using the search conditions generated by the search condition generation unit 105, thereby obtaining a plurality of search results as transportation schedule candidates (S407). Each of the search results can include information of a departure time from a departure place, an arrival time at a destination, via-points, an arrival time at each via-point, transportation means, and the like.

As shown in the specific examples in FIGS. 1A to 2, the display controller 103 displays the obtained transportation schedule candidates as icons on the schedule screen 10c (S409). When one icon (transportation schedule candidate) from among the obtained transportation schedule candidates is selected by the user (in S411, Yes), the display controller 103 displays the detail screen of the transportation route shown in the specific example as the screen 10d of FIG. 1B as needed, and then, the schedule registration unit 109 registers the selected transportation schedule candidate as a transportation schedule in the schedule management database (S413).

### 4 Hardware Configuration

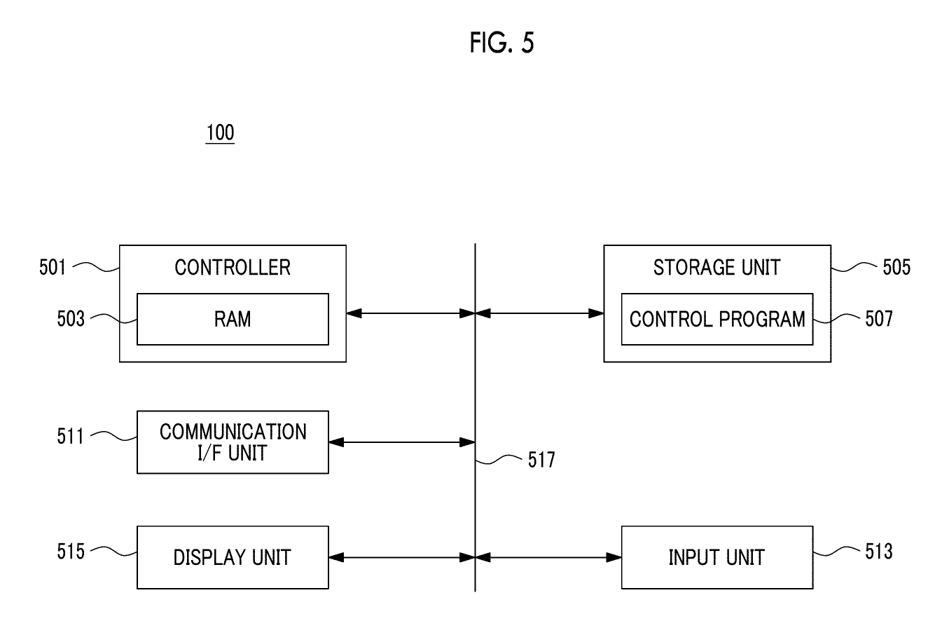

The hardware configuration of the information processing apparatus 100 that can be realized as a computer will be described referring to FIG. 5. The information processing apparatus 100 includes a controller 501, a storage unit 505, a communication interface (I/F) unit 511, an input unit 513, and a display unit 515, and the units are connected through a bus line 517.

The controller 501 includes a central processing unit (CPU) (not shown), a read only memory (ROM) (not shown), a random access memory (RAM) 503, and the like. The controller 501 executes a control program 507 stored in the storage unit 505, and is configured to be able to execute processing relating to each configuration shown in FIG. 3, in addition to the functions as a general computer. Specifically, the schedule information acquisition unit 101, the display controller 103, the search condition generation unit 105, the route search unit 107, and the schedule registration unit 109 shown in FIG. 3 can be realized as the control program 507 that is temporarily stored in the RAM 503, and then, operates on the CPU.

The RAM 503 temporarily stores a part or the whole of information that is included in codes included in the control program 507. In addition, the RAM 503 is also used as a work area when the CPU executes various kinds of processing.

The storage unit 505 is, for example, a nonvolatile storage medium, such as a hard disk drive (HDD) or a flash memory. The storage unit 505 stores an operating system (OS) for realizing the functions as the general computer or the control program 507 as an application program.

The communication I/F unit 511 is a device that performs communication with an external device, such as an external server, as needed. While a communication system that is used for communication between the information processing apparatus 100 and the external device is optional, for example, a public telephone network, the Internet, a combination of the public telephone network and the Internet, or the like is considered.

The input unit 513 is a device that receives an input operation from the user. As a specific example of the input unit 513, various buttons, a touch panel, a microphone, and the like can be exemplified.

The display unit 515 is a display device that presents various kinds of information to the user who operates the information processing apparatus 100. As a specific example of the display unit 515, for example, a liquid crystal display, an organic electro-luminescence (EL) display, or the like is exemplified.

### 5 Effects of Embodiment

As described above, in the information processing apparatus 100 according to the embodiment, when a plurality of schedules is registered, or the like, a plurality of transportation means between the schedules is searched, the plurality of obtained transportation means is presented to the user to be visually and easily understandable, and the user is made to select the transportation means that is to be registered as a schedule. With this, since a user who cannot read a daily pattern or a user who cannot entrust everything to a machine can feel a sense of achievement of selection, it is possible to meet various user's needs.

### 6 Appendix

The embodiments described above are intended to facilitate understanding of the disclosure, and are riot intended to interpret the disclosure in a limited way. Each of elements in the embodiments, and the arrangement, materials, conditions, shapes, sizes, and the like of the elements are not limited to those exemplified and can be appropriately changed. The configurations described in the different embodiments can be partially substituted or combined.

What is claimed is:

1. An information processing apparatus comprising:
a reading unit configured to read first schedule information including a start time and an end time of a schedule for a user and positional information for the user, from a schedule management database in which user's schedules are managed;
a search unit configured to perform a search based on a search condition according to the start time or the end time and the positional information included in the first schedule information to generate a plurality of pieces of transportation candidate information each including a transportation start time and a transportation end time;
a display unit configured to display a plurality of icons corresponding to the plurality of pieces of transportation candidate information on a display screen; and
a registration unit configured to register the transportation candidate information selected from among the plurality of pieces of transportation candidate information as transportation schedule information in the schedule management database.

2. The information processing apparatus according to claim 1, wherein:
the transportation candidate information includes transportation route information; and
when one of the plurality of icons displayed on the display screen is selected, the display unit displays the transportation route information related to the transportation candidate information corresponding to the selected icon.

3. The information processing apparatus according to claim 1, wherein, when one of the plurality of icons displayed on the display screen is selected, the display unit registers the transportation candidate information corresponding to the selected icon as the transportation schedule information in the schedule management database.

4. The information processing apparatus according to claim 1, wherein:
the reading unit reads the first schedule information and second schedule information including a start time later than the end time of the first schedule information; and
the search unit performs a search based on the search condition that the positional information included in the first schedule information is set as a departure place and the positional information included in the second schedule information is set as a destination.

5. The information processing apparatus according to claim 4, wherein the search unit performs a search based on the search condition that the same time as or a time later than the end time included in the first schedule information is set as a departure time and the same time as or a time earlier than the start time included in the second schedule information is set as an arrival time.

6. The information processing apparatus according to claim 1, wherein the search unit performs a search based on the search condition that the positional information included in the first schedule information is set as one of a departure place or a destination and the positional information related to a point registered in advance is set as the other of the departure place or the destination.

7. An information processing method comprising:
reading first schedule information including a start time and an end time of a schedule for a user and positional information for the user, from a schedule management database in which user's schedules are managed;
performing a search based on a search condition according to the start time or the end time and the positional information included in the first schedule information to generate a plurality of pieces of transportation candidate information each including a transportation start time and a transportation end time;
displaying a plurality of icons corresponding to the plurality of pieces of transportation candidate information on a schedule display screen; and
registering the transportation candidate information selected from among the plurality of pieces of transportation candidate information as transportation schedule information in the schedule management database.

8. A non-transitory computer-readable storage medium storing an information processing program causing a computer to execute
processing for reading first schedule information including a start time and an end time of a schedule for a user and positional information for the user, from a schedule management database in which user's schedules are managed,
processing for performing a search based on a search condition according to the start time or the end time and the positional information included in the first schedule information to generate a plurality of pieces of transportation candidate information each including a transportation start time and a transportation end time,
processing for displaying a plurality of icons corresponding to the plurality of pieces of transportation candidate information on a display screen, and
processing for registering the transportation candidate information selected from among the plurality of pieces of transportation candidate information as transportation schedule information in the schedule management database.
